(19) United States
(12) Patent Application Publication
(10) Pub. No.: US 2002/0048065 A1
(43) Pub. Date: Apr. 25, 2002

(54) AWG based OADM with improved crosstalk

(75) Inventor: Yosi Shani, Maccabim (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: LYNX PHOTONIC NETWORKS INC.

(21) Appl. No.: 09/845,203

(22) Filed: May 1, 2001

Related U.S. Application Data
(60) Provisional application No. 60/241,353, filed on Oct. 19, 2000.

(51) Int. Cl. G02B 6/02; G02B 6/18; H04J 14/02

(52) U.S. Cl. 359/127; 385/124

(57) ABSTRACT

An optical add/drop multiplexer (OADM) system with reduced crosstalk, and a method to reduce the system crosstalk in an OADM system are provided. The reduction of system crosstalk is achieved by the replacement of at least one of the common wavelength-independent switches in the drop switch or switch array, with at least one wavelength-dependent switch.

### CROSS REFERENCE TO PRIOR APPLICATIONS

This application claims priority from US Provisional Application Ser. No. 60/241353 filed Oct. 19, 2000.

### FIELD AND BACKGROUND OF THE INVENTION

Array Waveguide Gratings (AWG) are common components in present Optical Add/Drop Multiplexers (OADM), where they are used as network wavelength demultiplexers (DEMUX) and multiplexers (MUX), see FIG. 1. The advantages of the AWGs include: 1) low insertion loss [(A. Sugita, A. Kaneko, K. Okamoto, M. Itoh, A. Himeno, Y. Olunori, “Fabrication of very low insertion loss (˜0.8 dB) arrayed-waveguide grating with vertically tapered waveguides,” PD 1-2 paper in European Conference on Optical Communication, Nice, France, Sep. 26-30, 1999]; 2) integrability with the switch components [T. Saida, A. Kaneko, T. Goh, M. Himeno, K. Takiguchi, K. Okamoto, “A thermal silica-based optical add/drop multiplexer consisting of arrayed waveguide gratings and double gate thermo-optical switches,” Elect. Lett. Vol. 36, 528-529, 2000]; and 3) the microelectronic-based mass production technology with which they are produced. The main drawback of AWGs lies in the lower isolation between adjacent (neighboring) channels [S. Kamei, A. Kaneko, M. Ishii, A. Himeno, M. Itoh, A. Sugita, Y. Hibino, “32-channel very low crosstalk arrayed-waveguide grating multi/demultiplexer module using a cascade connection technique,” IFB1-1 paper in Integrated Photonics Research Conference, Quebec, Canada, Jul. 12-15, 2000] which affects the overall crosstalk performance.

Past attempts to improve the AWG (not the total system) crosstalk include improved designs [A.Sugita et al., see reference above], and a cascade of two AWGs [S. Kamei et al., see reference above]. Integration of AWGs and wavelength-dependent MZI splitters (interleavers) was shown by M. Abe et al (IPR 2000, IFB2, pp. 217-219) Abe's device consists of a Mach-Zehnder interferometer (MZI) interleaver followed by two AWGs with 50 GHz spacing. The wavelength-dependent MZI kicks off the demultiplexing by feeding even wavelengths to one AWG and odd wavelengths to the other AWG. Thus a 25 GHz spacing AWG is obtained with the two combined 50 GHz spacing AWGs.

### Crosstalk in the Express

The crosstalk in the OADM express path (not the add/drop paths) is the amount of λₗ in λ′ᵢ where λᵢ is the dropped (wavelength) data and λ′ᵢ is the added data (to the same wavelength slot).

In the OADM common use, see FIG. 1, the wavelengths are separated by a demultiplexer 10 (an AWG in our example), dropped by a column of N 1×2 switches 12, and gathered together by a multiplexer 14 (another AWG in our example) through N 2×1 add switches 16. However, since an AWG is not a perfect demultiplexer, some of the power in a λᵢ wavelength can be coupled to neighboring AWG ports, and not dropped by the λᵢ 1×2 drop switch. The amount of power of λᵢ routed to the neighboring ports is given by the AWG extinction ratio ER. Here, for simplicity, ER_{AWG} is taken as the coupling of λᵢ to the two neighbor (to λᵢ) λᵢ₊₁ and λᵢ₋₁ ports, and ER′_{AWG} as the coupling to all the other ports.

The (dropped) λᵢ wavelength which is coupled to the unwanted demultiplexer AWG ports can reach the AWG multiplexer output through its respective drop switches 12 and add switches 16. This unwanted λᵢ power adds to the OADM crosstalk. This amount of crosstalk is given by

2*[ER_{AWG}]²+(N_{eff}−2)*[ER′_{AWG}]² (1)

where N_{eff} is the number of effective AWG ports to which there is a non-negligible coupling (N_{eff}? N).

Another mechanism for crosstalk comes from the non-perfect 1×2 drop and the 2×1 add switches. Although wavelength λᵢ is dropped at the 1×2 drop switch, some of its power remains in the express path, with an extinction ratio of ER_{1×2}. At the 2×1 add switch, λᵢ is dropped again, since only the path that adds the λ′ᵢ data is open. Thus there is an added crosstalk of [ER_{1×2}]*[ER_{2×1}]. It is worthwhile mentioning that since the crosstalk comes from the switch cross stage, the switches should be designed with their best ER at the cross stage.

Typical extinction ratio numbers for integrated optics Silica on Si devices are ER_{AWG}=25 dB, ER′_{AWG}=35 dB, N=40, N_{eff}=10, ER_{1×2}=ER_{2×1}=30 dB. With these values one obtains a crosstalk of −47 dB (in eq. 1), which comes mainly from the adjacent (neighboring λᵢ) AWG ports.

Crosstalk in the Drop

As discussed above, in the AWG, some unwanted λⱼ wavelengths can be coupled to the desired λᵢ port. These unwanted λⱼ wavelengths are then dropped by the 1×2 drop switch together with λᵢ. The crosstalk in the OADM drop path is the sum of all the unwanted λⱼ wavelengths which are dropped together with a λᵢ wavelength to its drop port. This crosstalk is given by

2*[ER_{AWG}]+(N_{eff}−2)*[ER′_{AWG}] (2)

Using typical values from above, one obtains a crosstalk of −21 dB, which comes mainly from the adjacent AWG ports. This value of crosstalk is not acceptable for an OADM system and must be improved.

There is thus a recognized need for, and it would be advantageous to have a reduction in the crosstalk due to neighboring AWG ports in an OADM system.

### SUMMARY OF THE INVENTION

This invention presents a novel method and system for the reduction of crosstalk in OADM. The invention emphasizes the improvement of the overall crosstalk performance of the OADM, i.e. uses a “system” approach, rather than the improvement of just the AWG crosstalk performance. In a preferred embodiment, the overall crosstalk improvement is achieved without affecting the device complexity, through the replacement of the common 1×2 drop switch matrix with a wavelength sensitive switch matrix. In another preferred embodiment, one or more additional wavelength-dependent switches are cascaded with the drop switch matrix. Preferably, such a replacement is implemented in integrated optics technology through the use of asymmetric, wavelength-dependent MZI switches instead of the common, wavelength-independent symmetric MZI switches.

According to the present invention there is provided an optical add/drop multiplexer system having an add/drop path, the system comprising: a) a demultiplexer; and b) a drop switch matrix, optically coupled to the demultiplexer, for diverting at least a portion of light received from the demultiplexer to the add/drop path, the drop switch matrix including a plurality of switches, at least one of the switches being wavelength-dependent.

According to the present invention there is provided a method for reducing the crosstalk in an optical add/drop multiplexer system, the method comprising: a) providing a demultiplexer; b) optically connecting a drop switch matrix to the demultiplexer; and c) incorporating at least one wavelength-dependent switch in the drop switch matrix.

The present invention successfully addresses the shortcomings of the presently known configurations by providing a reduced crosstalk AWG based OADM system. Unlike Abe's configuration, the present invention uses the AWG for demultiplexing, while the MZIs are used for switching, not for demultiplexing.

### BRIEF DESCRIPTION OF THE DRAWINGS

The invention is herein described, by way of example only, with reference to the accompanying drawings, wherein:

FIG. 1 is a schematic description of an OADM layout with an input demultiplexer, a drop switch array, an add switch array and an output multiplexer;

FIG. 2 is a schematic description of the transmission spectra of a common wavelength-independent switch and a wavelength-dependent switch;

FIG. 3 is a schematic description of an OADM layout with a demultiplexer, drop and add switch arrays, a multiplexer, and N×M switch matrices at the drop and add ports.

FIG. 4 shows a 4×4 switch matrix with the first switch column replaced by wavelength- dependent switches;

FIG. 5a is a top view of a symmetric, integrated Mach Zehnder Interferometer switch;

FIG. 5b is a top view of an asymmetric, integrated Mach Zehnder Interferometer switch;

### DESCRIPTION OF THE PREFERRED EMBODIMENTS

The present invention is of a system and method for the reduction of crosstalk in OADM. Specifically, the present invention can be used to reduce the overall crosstalk in an OADM system, by employing a combination of one or more asymmetric MZI-based switches with an AWG.

The principles and operation of the AWG-based OADM with improved crosstalk according to the present invention may be better understood with reference to the drawings and the accompanying description.

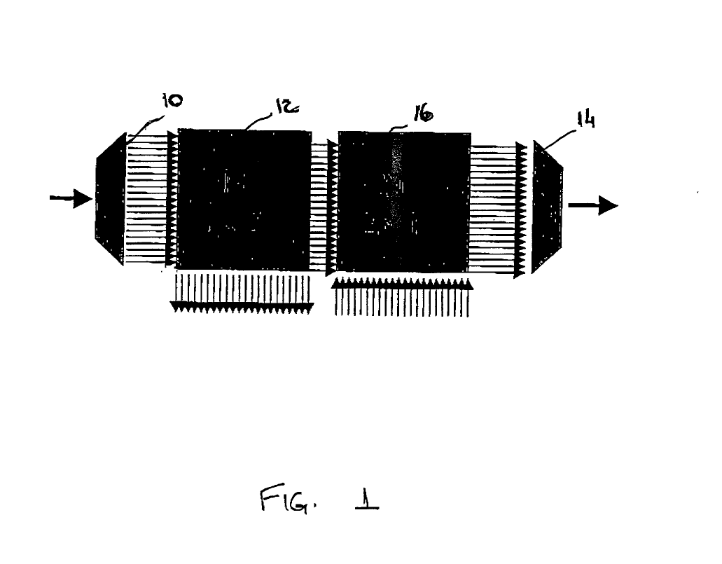

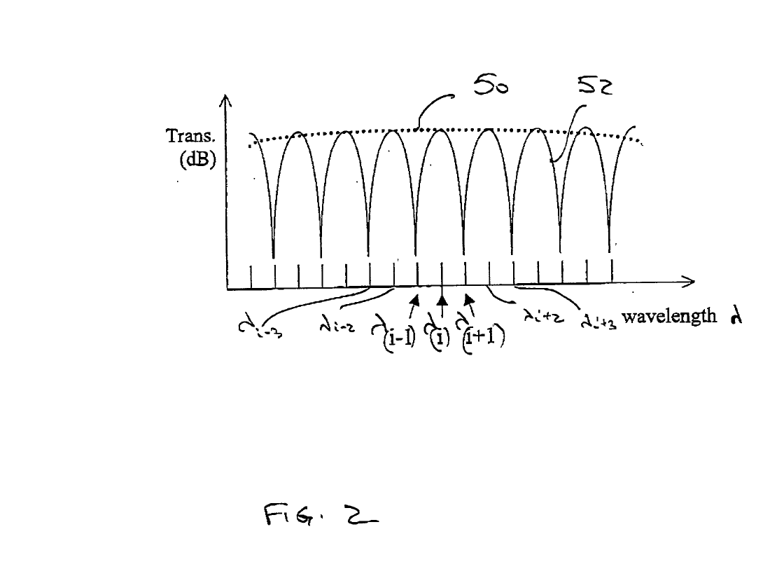

Referring now to the drawings, FIG. 2 illustrates schematically a transmission spectrum 50 of a wavelength-independent switch, and a transmission spectrum 52 of a wavelength-dependent switch. Spectrum 50 has almost no wavelength dependency, while spectrum 52 has maximum transmission at wavelengths λᵢ, λᵢ₋₂, λᵢ₊₂ . . . and minimum transmission at the adjacent λᵢ₋₁ and λᵢ₊₁ wavelengths, as well as at the λᵢ₋₃, λᵢ₊₃, etc. wavelengths. In order to improve the OADM crosstalk performance, which is limited by the AWG crosstalk, in a preferred embodiment of the present invention, one or more of the common, wavelength-independent 1×2 drop switches normally used in configurations such as switch matrix 12 of FIG. 1 are replaced with wavelength-dependent 1×2 switches. As an example, for a 100 GHz AWG, a 1×2 wavelength-dependent drop switch is preferably designed with a 200 GHz periodicity.

Improved Express Crosstalk

As discussed above, the (dropped) λᵢ wavelength that is coupled to the unwanted demultiplexer AWG ports can reach the output AWG multiplexer through the 1×2 drop switches and the 2×1 add switches. If one traces the adjacent (λᵢ₊₁ and λᵢ₋₁) wavelength paths, one sees that the light with λᵢ must pass through the 1×2 (wavelength-dependent) and the 2×1 (wavelength-independent) switches that drop and add respectively the adjacent wavelengths, λᵢ₊₁ and λᵢ₋₁. Therefore in its adjacent ports, the light with λᵢ passes through one forbidden switch and the total loss is given by:

2*[ER_{1×2}]*[ER_{AWG}]² or 2*[ER_{2×1}]*[ER_{AWG}]² (3)

where the switches are in their cross or bar stages. The contribution of the non-adjacent wavelengths is

1/2*(N_{eff}−2)*[ER_{1×2}]*[ER′_{AWG}]²+½*(N_{eff}−2)*[ER′_{AWG}]² (4)

The first term comes from the odd (relative to i) ports, while the second term comes from the even (relative to i) ports. In the above we assume that ER_{1×2}=ER_{2×1}. After neglecting the first small term in eq. 4 (which is multiplied by ER_{1×2}), one obtains for the crosstalk (by adding equations 3 and 4).

2*[ER_{2×1}]*[ER_{AWG}]²+½*(N_{eff}−2)*[ER′_{AWG}]²+[ER_{1×2}]*[ER_{2×1}] (5)

Thus, with the values specified before, the crosstalk is improved from −47 dB to −57 dB.

Improved Drop Crosstalk

As discussed above, at the AWG, some of the unwanted λⱼ wavelengths can be coupled to the λᵢ port. These unwanted λⱼ wavelengths are then dropped by the respective 1×2 drop switch together with the desired λᵢ wavelength. However, with a wavelength-dependent 1×2 drop switch as suggested in the present invention, the adjacent wavelengths are not dropped, nor are the other odd (to λᵢ) wavelengths. Thus, the crosstalk is given by

2*[ER_{AWG}]*(N_{eff}−2)* [ER_{1×2}]½* [ER′_{AWG}] (6)

The first term here is much smaller than the second term and the crosstalk can be reduced to

½*(N_{eff}−2)*[ER′_{AWG}] (7)

With the values specified before, the crosstalk, eq. 7, is improved from −21 dB to −29 dB.

Additional Improvements

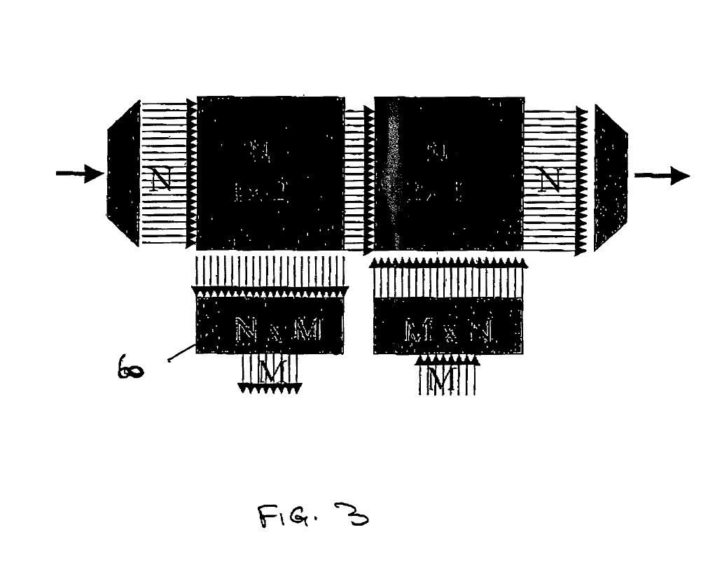

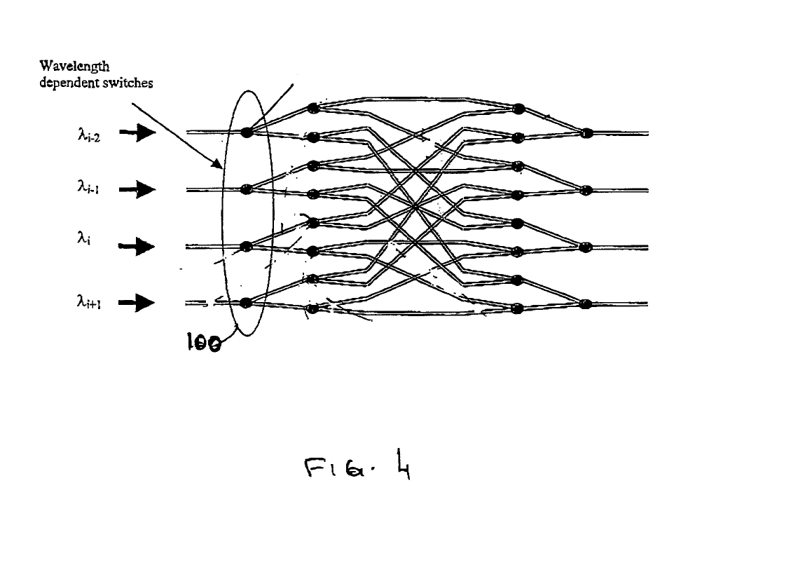

The same concept of adding wavelength dependency to the switches can be extended to more complex OADM systems for further improving the crosstalk. One or more switches with wavelength dependency can be combined (optically connected or “cascaded”) in the drop paths with a N×M switch matrix, as shown in FIG. 3. This combination yields a “cascaded” switch configuration. In FIG. 3, a common use N×M switch 60 includes normally wavelength-independent switches. By replacing one or more of the switches in the first column of the N×M switch matrix with wavelength-dependent switches, as discussed below, the crosstalk in the drop, and consequently in the entire system, is reduced. The effect of the “cascaded” switch is to provide additional filtering. A preferred embodiment of such an improved configuration is shown in FIG. 4.

In the N×M switch matrix of FIG. 4, one or more of the switches in the first column of common switches 100 are preferably replaced with wavelength-dependent switches, each such wavelength-dependent switch centered according to its input port wavelengths. For a 100 GHz AWG, a 200 GHz wavelength-dependent 1×2 drop switch, and 400 GHz wavelength-dependent switches for the first column of switches (in the N×M switch matrix), the drop crosstalk can be reduced to 1/4*(N_{eff}−2)* [ER′_{AWG}], which is −32 dB with the values specified above.

Example of Integrated Optics Switches for the Proposed OADM

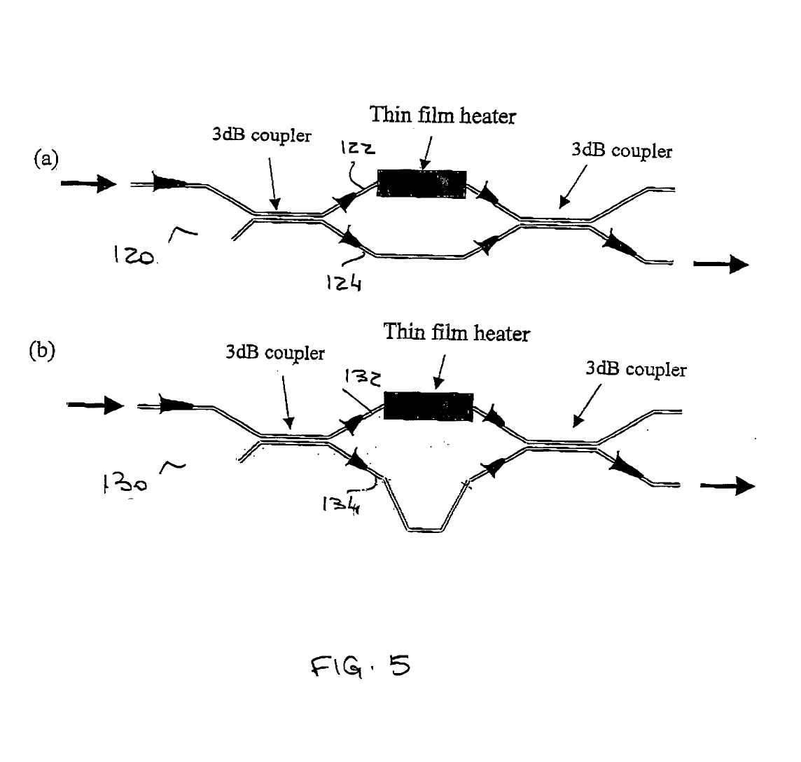

A preferred implementation of wavelength-independent switches, as well as of the wavelength-dependent switches used in the preferred embodiments of the present invention, is the fabrication of, respectively, symmetric and asymmetric MZI switches using integrated optics technologies, as illustrated in FIGS. 5a, b. Specifically, the MZI switches, switch arrays, and switch matrices of the present invention can be implemented by using Silica on Si technologies. In the symmetric MZI 120 of FIG. 5a there is typically no path difference between waveguide arms 122 and 124 (or there is only a λ/2 n or λ/4 n path difference), while in the asymmetric MZI 130 of FIG. 5b, there is a path difference between waveguide arms 132 and 134 of ΔL=c /(2*n*Δf) [see M. Kawachi, “Silica waveguides on silicon and their application to integrated-optic components,” Optical and Quantum Electronics, vol. 22, pp. 391-416, 1990]. In the expression above, c is the light velocity, n is the waveguide refractive index, and Δf is the frequency spacing between two adjacent wavelengths. Both switches can be fabricated with the same technology at the same time, the only difference between them being the lengths of the arms. Thus, the suggested improvement of replacing one or more of the symmetric MZIs with asymmetric MZIs in any chosen system configuration (single switch, switch array, N×M switch matrix, etc.) does not add to the system complexity, when the fabrication is by integrated optics technologies.

While the invention has been described with respect to a limited number of embodiments, it will be appreciated that many variations, modifications and other applications of the invention may be made.

What is claimed is:

1. An optical add/drop multiplexer system having an add/drop path, comprising:
a) a demultiplexer; and
b) a drop switch matrix, optically coupled to said demultiplexer, for diverting at least a portion of light received from said demultiplexer to the add/drop path, said drop switch matrix including a plurality of switches, at least one of said switches being wavelength-dependent.

2. The optical add/drop multiplexer system of claim 1 further comprising a multiplexer connected to said drop switch matrix.

3. The optical add/drop multiplexer system of claim 1, wherein said drop switch matrix is a 1×2 drop array.

4. The optical add/drop multiplexer system of claim 1, wherein said demultiplexer is an Array Waveguide Grating.

5. The optical add/drop multiplexer system of claim 2, wherein said multiplexer is an Array Waveguide Grating.

6. The optical add/drop multiplexer system of claim 1, wherein said drop switch matrix is made using integrated optics technology.

7. The optical add/drop multiplexer system of claim 1, wherein said at least one wavelength-dependent switch is an asymmetric Mach Zehnder Interferometer switch.

8. The optical add/drop multiplexer system of claim 7, wherein said at least one wavelength-dependent switch is made of Silica on Si.

9. The optical add/drop multiplexer system of claim 1, wherein said at least one wavelength-dependent switch is cascaded with at least one different wavelength-dependent switch, thereby forming at least one cascaded wavelength-dependent switch.

10. The optical add/drop multiplexer system of claim 9, wherein said at least one different wavelength-dependent switch is implemented in a N×M switch matrix.

11. The optical add/drop multiplexer system of claim 10, wherein said at least one different wavelength-dependent switch is implemented in the first switch column of said N×M switch matrix.

12. The optical add/drop multiplexer system of claim 9, wherein said N×M switch matrix is fabricated using integrated optics technology.

13. A method for reducing the crosstalk in an optical add/drop multiplexer system, the method comprising:
a) providing a demultiplexer
b) optically connecting a drop switch matrix to said demultiplexer; and
c) incorporating at least one wavelength-dependent switch in said drop switch matrix.

14. The method of claim 13, further comprising connecting a multiplexer to said drop switch matrix.

15. The method of claim 13, wherein said drop switch matrix is a 1×2 drop array.

16. The method of claim 13, wherein said demultiplexer is an Array Waveguide Grating.

17. The method of claim 14, wherein said multiplexer is an Array Waveguide Grating.

18. The method of claim 13, wherein said drop switch matrix is made using integrated optics technology.

19. The method of claim 13, wherein said at least one wavelength-dependent switch is an asymmetric Mach Zehnder Interferometer switch.

20. The method of claim 13, wherein said at least one wavelength-dependent switch is made of Silica on Si.

21. The method of claim 13, further comprising: optically connecting at least one different wavelength-dependent switch to said at least one wavelength-dependent switch, thereby forming at least one cascaded wavelength-dependent switch.

22. The method of claim 21, wherein said at least one different wavelength-dependent switch is implemented in a N×M switch matrix.

23. The method of claim 22, wherein said at least one different wavelength-dependent switch is implemented in the first switch column of said N×M switch matrix.

24. The method of claim 22, wherein said N×M switch matrix is fabricated using integrated optics technology.
